(19) United States
(12) Patent Application Publication
(10) Pub. No.: US 2026/0359227 A1
(43) Pub. Date: Nov. 12, 2026

(54) PREDICTIVE CACHE MANAGEMENT FOR IO BURSTS

(71) Applicant: Dell Products L.P., Round Rock, TX (US)

(72) Inventors: Arieh Don, Newton, MA (US); Ramesh Doddaiah, Westborough, MA (US); Krishna Deepak Nuthakki, Bangalore (IN)

(73) Assignee: Dell Products L.P., Round Rock, TX (US)

(21) Appl. No.: 19/199,689

(22) Filed: May 6, 2025

(51) Int. Cl. G06F 12/0871; G06F 9/455; G06F 11/34

(52) U.S. Cl. CPC G06F 12/0871; G06F 9/45558; G06F 11/3442; G06F 2009/45579

(57) ABSTRACT

One or more aspects of the present disclosure relate to enhancing cache effectiveness during high input/output (IO) load periods in storage arrays. Embodiments predict future high IO load periods by analyzing historical IO patterns using machine learning techniques that integrate Long Short-Term Memory (LSTM) networks and Bayesian Change Point Detection. In some embodiments, upon predicting an upcoming high IO period, cache resources are proactively managed by tracking current cache utilization and freeing cache buffers through various mechanisms. These mechanisms include increasing write urgency for pending data, evicting previously read data from cache buffers, and, in embodiments with separate read and write caches, relocating read cache buffers to write cache to increase capacity. Embodiments leverage Fabric Device Management Interface (FDMI) information and virtual machine designations to correlate IO patterns across hosts and applications, enabling accurate prediction of IO bursts and their duration through analysis of historical patterns.

### BACKGROUND

Modern software applications leverage host caching as local storage to enhance performance, with servers commonly equipped with terabyte-scale cache capabilities. In typical deployments, applications like databases read entire datasets into cache memory for accelerated processing. Storage arrays incorporate sophisticated caching mechanisms, including separate write and read caches in some implementations, while others utilize unified cache architectures for both operations.

These storage systems employ various caching strategies, such as write-pending mechanisms that temporarily hold data before committing to permanent storage and read caching that maintains previously accessed data to improve hit rates. Host systems interact with storage arrays through multiple Host Bus Adapters (HBAs), with Fabric Device Management Interface (FDMI) technology enabling correlation of input/output (IO) operations across different HBAs to their originating hosts and virtual machines. This infrastructure allows storage arrays to track detailed IO patterns and performance metrics at various levels, including per host, per virtual machine (VM), and per application basis.

### SUMMARY

One or more aspects of the present disclosure relate to managing cache resources in a storage array. In embodiments, a future high input/output (IO) load period is predicted based on historical IO patterns from one or more hosts connected to a storage array. A current cache utilization of the storage array is also determined. Whether cache resources should be freed is determined based on the predicted future high IO load period and the current cache utilization. Cache resources are freed prior to the predicted high IO load period.

In embodiments, the historical IO patterns can be analyzed using Long Short-Term Memory (LSTM) networks to predict future IO loads in a time series. In addition, Bayesian Change Point Detection can be used to identify bursts by detecting sudden changes in mean and variance within LSTM-generated forecasts.

In embodiments, host name information can be collected from Fabric Device Management Interface (FDMI). Additionally, virtual machine (VM) designations can be collected. Further, IO statistics corresponding to each of the one or more hosts can be analyzed.

In embodiments, write pending data in cache buffers can be identified. Furthermore, a write urgency for the write pending data can be increased to free up cache buffers before the predicted high IO load period.

In embodiments, read cache buffers containing previously read data can be identified. Additionally, the previously read data can be evicted from the read cache buffers to make the read cache buffers available for the predicted high IO load period.

In embodiments, read cache buffers can be relocated to write cache buffers to increase write cache capacity when the storage array has separate read and write caches.

In embodiments, read data can be evicted from cache buffers to free cache resources.

In embodiments, Long Short-Term Memory (LSTM) neural networks can be used to analyze historical IO patterns and predict future IO load values.

In embodiments, Bayesian Change Point detection can be used to identify IO burst onset and determine IO burst duration.

In embodiments, burst length can be determined by measuring time differences between consecutive detected change points in the Bayesian Change Point Detection.

Other technical features may be readily apparent to one skilled in the art from the following figures, descriptions, and claims.

### BRIEF DESCRIPTION OF THE DRAWINGS

The preceding and other objects, features, and advantages will be apparent from the following more particular description of the embodiments, as illustrated in the accompanying drawings. Like reference, characters refer to the same parts throughout the different views. The drawings are not necessarily to scale, emphasis instead being placed upon illustrating the embodiments' principles.

FIG. 1 illustrates a distributed network environment in accordance with embodiments of the present disclosure.

FIG. 2 is a cross-sectional view of a storage device in accordance with embodiments of the present disclosure.

FIG. 3 is a block diagram of engines of a storage array, including director boards, in accordance with embodiments of the present disclosure.

FIG. 4 is a block diagram of a communications network in accordance with embodiments of the present disclosure.

FIG. 5 is a block diagram of a controller in accordance with embodiments of the present disclosure.

FIG. 6 is a flow diagram of a method for managing cache resources in a storage array per embodiments of the present disclosure.

### DETAILED DESCRIPTION

Modern software applications extensively utilize host caching as local storage to enhance performance capabilities. In typical deployments, servers are equipped with terabyte-scale cache memory, allowing applications such as databases to read entire datasets into cache for accelerated processing. These applications periodically write cached data to permanent storage locations, such as storage arrays, through operations known as memory flushes.

Memory flushes can occur in either synchronous or asynchronous modes. In synchronous operations, applications pause processing until all data is destaged, while in asynchronous operations, applications continue processing while data is being written to storage. For example, in financial institutions, banking operations often require synchronous processing to ensure transaction integrity. When processing ATM withdrawals, some banks configure their systems to wait until the transaction data is completely written to storage before allowing the withdrawal to proceed, ensuring zero data loss at the cost of transaction speed.

Storage arrays implement various caching architectures, with some incorporating separate write and read caches while others utilize unified cache structures. During high IO load periods, these caching mechanisms must manage both write-pending data, which cannot be evicted until written to disk, and read cache data awaiting potential re-reads. In banking scenarios, ATM transactions illustrate the critical nature of cache management-some banks configure their systems to wait for complete data dumps before allowing additional withdrawals, prioritizing data integrity over transaction speed.

Embodiments of the present disclosure provide sophisticated methods for predicting and managing high IO load periods in storage arrays. These embodiments leverage machine learning techniques, specifically integrating Long Short-Term Memory (LSTM) networks and Bayesian Change Point Detection (BCP), to accurately forecast IO bursts and estimate their duration. The LSTM networks analyze historical patterns to predict future values in the time series, while BCP identifies bursts by detecting sudden changes in mean and variance within the LSTM-generated forecasts.

In various embodiments, the prediction capabilities are enhanced through the collection and analysis of detailed IO statistics. These embodiments utilize Fabric Device Management Interface (FDMI) information to correlate IO operations across multiple Host Bus Adapters (HBAs) to their originating hosts. Additionally, virtual machine (VM) designations enable tracking of IO patterns at the VM level, allowing for more precise prediction of future IO pressure based on historical statistics.

For financial institutions, these embodiments are particularly valuable in managing mixed workloads with varying priorities. For instance, a bank's core transaction processing system might require guaranteed synchronous writes for every transaction, while concurrent reporting or analysis workloads can operate asynchronously. The system can predict these periodic synchronous dumps based on historical patterns and prepare cache resources accordingly.

Upon predicting an upcoming high IO load period, embodiments of the present disclosure implement proactive cache resource management strategies. These strategies begin with tracking current cache utilization levels. When high cache utilization is detected before a predicted IO burst, the storage array prioritizes evicting data from cache to free buffer space.

For write cache management, embodiments increase write urgency when there are numerous cache buffers containing unwritten data. This proactive approach to writing pending data occurs before the high IO load period, ensuring maximum cache buffer availability when needed. In banking environments, this capability is crucial during high-volume transaction periods when multiple systems simultaneously require high-priority cache access.

Similarly, for read cache management, when high usage of read cache buffers is detected, embodiments implement strategies to free these slots by evicting previously read data that has not yet been removed from the Least Recently Used (LRU) queue. This is particularly relevant for financial institutions during periods of heavy reporting or analysis workloads, where read operations might compete with critical write operations.

In embodiments where storage arrays deploy separate write and read caches, additional optimization techniques are employed. These embodiments can dynamically relocate read cache buffers to the write cache to increase its capacity in preparation for anticipated write-intensive workloads.

The effectiveness of these embodiments is particularly evident in scenarios where IO floods occur in regular intervals or cycles, such as scheduled database dumps or backup operations. For financial institutions, these predictable patterns might include real-time transaction processing, daily backup operations, or periodic regulatory reporting requirements.

Through the combination of advanced machine learning techniques, sophisticated IO pattern analysis, and intelligent cache resource management, embodiments of the present disclosure provide comprehensive solutions for enhancing cache effectiveness during high IO burst periods. These capabilities enable storage arrays to better serve both synchronous and asynchronous workloads while maintaining optimal performance levels across various operational scenarios, particularly in demanding environments like financial institutions where data integrity and processing efficiency are paramount.

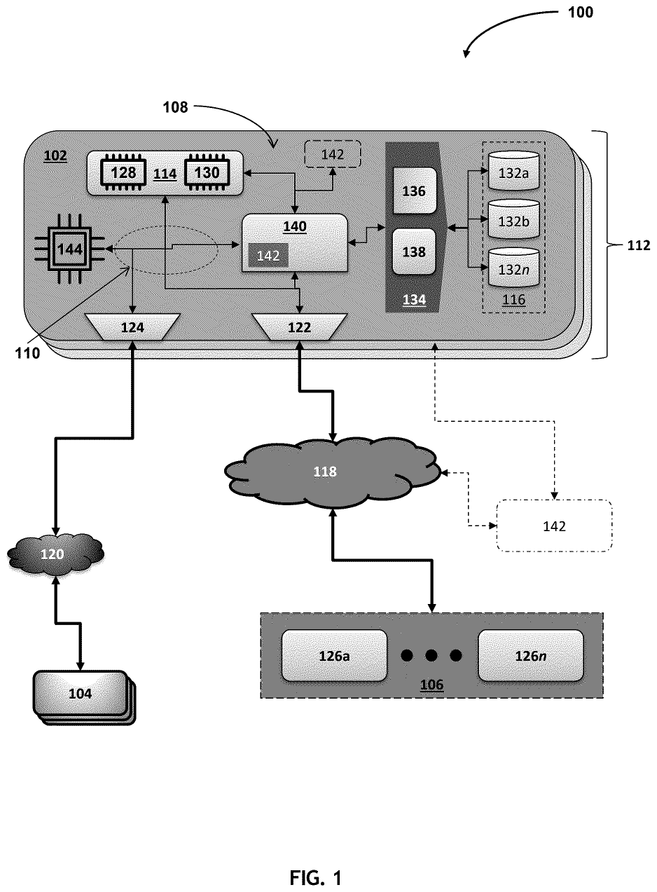

Regarding FIG. 1, a distributed network environment 100 can include a storage array 102, a remote system 104, and hosts 106. In embodiments, the storage array 102 can include components 108 that perform one or more distributed file storage services. In addition, the storage array 102 can include one or more internal communication channels 110 like Fibre channels, buses, and communication modules that communicatively couple the components 108. Further, the distributed network environment 100 can define an array cluster 112, including the storage array 102 and one or more other storage arrays.

In embodiments, the storage array 102, components 108, and remote system 104 can include a variety of proprietary or commercially available single or multi-processor systems (e.g., parallel processor systems). Single or multi-processor systems can include central processing units (CPUs), graphical processing units (GPUs), and others. Additionally, the storage array 102, remote system 104, and hosts 106 can virtualize one or more of their respective physical computing resources (e.g., processors (not shown), memory 114, and persistent storage 116).

In embodiments, the storage array 102 and, e.g., one or more hosts 106 (e.g., networked devices) can establish a network 118. Similarly, the storage array 102 and a remote system 104 can establish a remote network 120. Further, the network 118 or the remote network 120 can have a network architecture that enables networked devices to send/receive electronic communications using a communications protocol. For example, the network architecture can define a storage area network (SAN), local area network (LAN), wide area network (WAN) (e.g., the Internet), an Explicit Congestion Notification (ECN), Enabled Ethernet network, and the like. Additionally, the communications protocol can include Remote Direct Memory Access (RDMA), TCP, IP, TCP/IP protocol, SCSI, Fibre Channel, Remote Direct Memory Access (RDMA) over Converged Ethernet (ROCE) protocol, Internet Small Computer Systems Interface (ISCSI) protocol, NVMe-over-fabrics protocol (e.g., NVMe-over-ROCEv2 and NVMe-over-TCP), and the like.

Further, the storage array 102 can connect to the network 118 or remote network 120 using one or more network interfaces. The network interface can include a wired/wireless connection interface, bus, data link, and the like. For example, a host adapter (HA 122), e.g., a Fibre Channel Adapter (FA) and the like, can connect the storage array 102 to the network 118 (e.g., SAN). Further, the HA 122 can receive and direct IOs to one or more of the storage array's components 108, as described in greater detail herein.

Likewise, a remote adapter (RA 124) can connect the storage array 102 to the remote network 120. Further, the network 118 and remote network 120 can include communication mediums and nodes that link the networked devices. For example, communication mediums can include cables, telephone lines, radio waves, satellites, infrared light beams, etc. The communication nodes can also include switching equipment, phone lines, repeaters, multiplexers, and satellites. Further, the network 118 or remote network 120 can include a network bridge that enables cross-network communications between, e.g., the network 118 and remote network 120.

In embodiments, hosts 106 connected to the network 118 can include client machines 126a-n, running one or more applications. The applications can require one or more of the storage array's services. Accordingly, each application can send one or more input/output (IO) messages (e.g., a read/write request or other storage service-related request) to the storage array 102 over the network 118. Further, the IO messages can include metadata defining performance requirements according to a service level agreement (SLA) between hosts 106 and the storage array provider.

In embodiments, the storage array 102 can include a memory 114, such as volatile or nonvolatile memory. Further, volatile and nonvolatile memory can include random access memory (RAM), dynamic RAM (DRAM), static RAM (SRAM), and the like. Moreover, each memory type can have distinct performance characteristics (e.g., speed corresponding to reading/writing data). For instance, the types of memory can include register, shared, constant, user-defined, and the like. Furthermore, in embodiments, the memory 114 can include global memory (GM 128) that can cache IO messages and their respective data payloads. Additionally, the memory 114 can include local memory (LM 130) that stores instructions that the storage array's processors 144 can execute to perform one or more storage-related services. For example, the storage array 102 can have a multi-processor architecture that includes one or more CPUs (central processing units) and GPUs (graphical processing units).

In addition, the storage array 102 can deliver its distributed storage services using persistent storage 116. For example, the persistent storage 116 can include multiple thin-data devices (TDATs) such as persistent storage drives 132a-n. Further, each TDAT can have distinct performance capabilities (e.g., read/write speeds) like hard disk drives (HDDs) and solid-state drives (SSDs).

Further, the HA 122 can direct one or more IOs to an array component 108 based on their respective request types and metadata. In embodiments, the storage array 102 can include a device interface (DI 134) that manages access to the array's persistent storage 116. For example, the DI 134 can include a disk adapter (DA 136) (e.g., storage device controller), flash drive interface 138, and the like that control access to the array's persistent storage 116 (e.g., storage devices 132a-n).

Likewise, the storage array 102 can include an Enginuity Data Services processor (EDS 140) that can manage access to the array's memory 114. Further, the EDS 140 can perform one or more memory and storage self-optimizing operations (e.g., one or more machine learning techniques) that enable fast data access. Specifically, the operations can implement techniques that deliver performance, resource availability, data integrity services, and the like based on the SLA and the performance characteristics (e.g., read/write times) of the array's memory 114 and persistent storage 116. For example, the EDS 140 can deliver hosts 106 (e.g., client machines 126a-n) remote/distributed storage services by virtualizing the storage array's memory/storage resources (memory 114 and persistent storage 116, respectively).

In embodiments, the storage array 102 can also include a controller 142 (e.g., management system controller) that can reside externally from or within the storage array 102 and one or more of its components 108. When external from the storage array 102, the controller 142 can communicate with the storage array 102 using any known communication connections. For example, the communications connections can include a serial port, parallel port, network interface card (e.g., Ethernet), etc. Further, the controller 142 can include logic/circuitry that performs one or more storage-related services. For example, the controller 142 can have an architecture designed to manage the storage array's computing, processing, storage, and memory resources as described in greater detail herein.

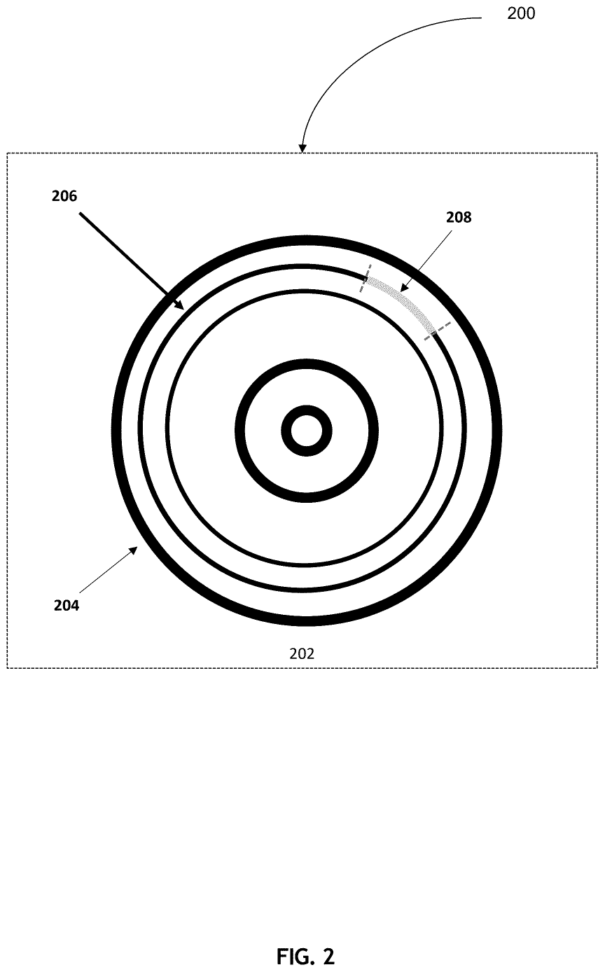

Regarding FIG. 2, the storage array's EDS 140 can virtualize the array's persistent storage 116. Specifically, the EDS 140 can virtualize a storage device 200, which is substantially like one or more of the storage devices 132a-n. For example, the EDS 140 can provide a host, e.g., client machine 126a, with a virtual storage device (e.g., thin-device (TDEV)) that logically represents zero or more portions of each storage device 132a-n. For example, the EDS 140 can establish a logical track using zero or more physical address spaces from each storage device 132a-n. Specifically, the EDS 140 can establish a continuous set of logical block addresses (LBA) using physical address spaces from the storage devices 132a-n. Thus, each (LBA) represents a corresponding physical address space from one of the storage devices 132a-n. For example, a track can include 256 LBAs, amounting to 128 kb of physical storage space. Further, the EDS 140 can establish the TDEV using several tracks based on the desired storage capacity of the TDEV. The EDS 140 can also establish extents that logically define a group of tracks.

In embodiments, the EDS 140 can provide each TDEV with a unique identifier (ID) like a target ID (TID). Additionally, EDS 140 can establish a logical unit number (LUN) that maps each track of a TDEV to its corresponding physical track location using pointers. Further, the EDS 140 can also generate a searchable data structure, mapping logical storage representations to their corresponding physical address spaces. Thus, EDS 100 can enable the HA 122 to present the hosts 106 with the logical storage representations based on host or application performance requirements.

For example, the persistent storage 116 can include an HDD 202 with stacks of cylinders 204. Like a vinyl record's grooves, each cylinder 204 can include one or more tracks 206. Each track 206 can include continuous sets of physical address spaces representing each of its sectors 208 (e.g., slices or portions thereof). The EDS 140 can provide each slice/portion with a corresponding logical block address (LBA). The EDS 140 can also group sets of continuous LBAs to establish one or more tracks. Further, the EDS 140 can group a set of tracks to establish each extent of a virtual storage device (e.g., TDEV). Thus, each TDEV can include tracks and LBAs corresponding to one or more of the persistent storage 116 or portions thereof (e.g., tracks and address spaces).

As stated herein, the persistent storage 116 can have distinct performance capabilities. For example, an HDD architecture is known by skilled artisans to be slower than an SSD's architecture. Likewise, the array's memory 114 can include different memory types, each with distinct performance characteristics described herein. In embodiments, the EDS 140 can establish a storage or memory hierarchy based on the SLA and the performance characteristics of the array's memory/storage resources. For example, the SLA can include one or more Service Level Objectives (SLOs) specifying performance metric ranges (e.g., response times and uptimes) corresponding to the hosts' performance requirements.

Further, the SLO can specify service level (SL) tiers corresponding to each performance metric range and categories of data importance (e.g., critical, high, medium, low). For example, the SLA can map critical data types to an SL tier requiring the fastest response time. Thus, the storage array 102 can allocate the array's memory/storage resources based on an IO workload's anticipated volume of IO messages associated with each SL tier and the memory hierarchy.

For example, the EDS 140 can establish the hierarchy to include one or more tiers (e.g., subsets of the array's storage and memory) with similar performance capabilities (e.g., response times and uptimes). Thus, the EDS 140 can establish fast memory and storage tiers to service host-identified critical and valuable data (e.g., Platinum, Diamond, and Gold SLs). In contrast, slow memory and storage tiers can service host-identified, non-critical, less valuable data (e.g., Silver and Bronze SLs). The EDS 140 can also define “fast” and “slow” performance metrics based on relative performance measurements of the array's memory 114 and persistent storage 116. Thus, the fast tiers can include memory 114 and persistent storage 116, with relative performance capabilities exceeding a first threshold. In contrast, slower tiers can include memory 114 and persistent storage 116, with relative performance capabilities falling below a second threshold. Further, the first and second thresholds can correspond to the same threshold.

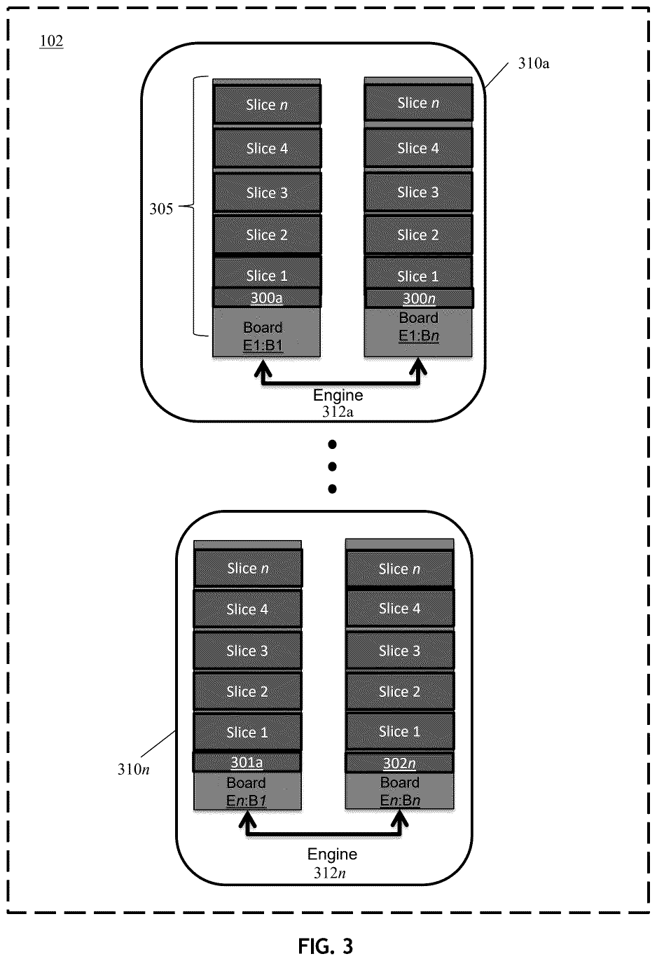

Regarding FIG. 3, the storage array 102 includes engines 312a-n that deliver storage services. Each engine 312a-n has hardware circuity or software components required to perform the storage services. Additionally, the array 102 can house each engine 312a-n in one or more of its shelves (e.g., housing) 310a-n that interface with the array's cabinet or rack (not shown).

In embodiments, each engine 312a-n can include director boards (boards) E1:B1-E1:Bn, En:B1-En:Bn. The boards E1:B1-E1:Bn, En:B1-En:Bn can have slices 305, each comprising hardware or software elements that perform specific storage services. Each board's slices 1-n can correspond to or emulate one or more of the storage array's components 108 described in FIG. 1. For example, each board's Slice 1 can correspond to or emulate the EDS 140 or controller 142 of FIG. 1. In embodiments, the slices 2-n can emulate one or more of the array's other components 101. Further, the boards B1-n can include memory 300a-n-301a-n, respectively. The memory 300a-n-301a-n can be dynamic random-access memory (DRAM).

In embodiments, each emulated EDS 140 (collectively “EDS 140”) can provision its respective board with memory from the array's global memory 128. For example, the EDS 140 can uniformly carve out at least one global memory section into x-sized memory portions 300a-n-301a-n. Further, the EDS 140 can size each global memory section or the x-sized memory portions 300a-n-301a-n to store data structure filters like cuckoo filters. The EDS 140 can size each global memory section or the x-sized portions based on an IO workload's predicted metrics related to the amount and frequency of sequential IO write patterns. For instance, the predicted metrics can define the amount of data the x-sized memory portions 300a-n-301a-n can be required to store.

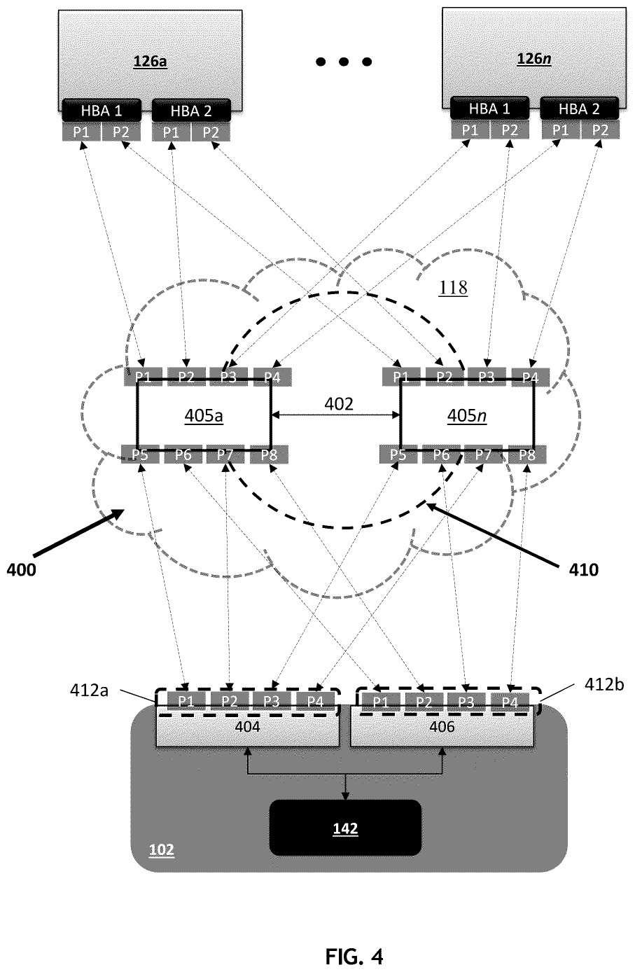

Regarding FIG. 4, a network (e.g., a storage area network) 118 can include one or more interconnected nodes (e.g., switches) 405a-n that define a structure and flow of information between networked devices. In embodiments, the network can interconnect the nodes 405a-n using links 410. The links 410 can allow the nodes 405a-n to exchange messages using one or more communication protocols. The communications protocols can define a method (e.g., rules, syntax, semantics, and the like) by which the nodes 405a-n can pass messages and signals to other networked devices. Further, the protocol can define a communications synchronization process and error recovery methods. The network 118 can implement the protocol using hardware, software, or a combination of both. The protocol's rules, syntax, and semantics can include, e.g., a circuit switching, message switching, or packet switching technique. In embodiments, the nodes 405a-n can comprise networking hardware such as computing nodes (e.g., computers), servers, networking hardware, bridges, switches, hubs, and the like.

For example, the nodes 405a-n can correspond to Fibre Channel (FC) switches connected via an inter-switch link (ISL) 402. The ISL 402 allows for communication and data transfer between switches, enabling the creation of larger fabric topologies and providing redundancy. ISLs are typically high-speed links that carry traffic between switches, allowing networked devices connected to different switches to communicate with each other as if they were on the same switch. In the context of SAN FC Zoning, ISLs are crucial in connecting multiple switches to form a larger, more flexible network infrastructure.

The network 118 can arrange the nodes 405a-n to define one or more of a Chain Network (CHN), Y-Network (YN), Wheel Network (WN), Circle Network (CIRN), All-Channel Network (ACN) such as a Star Network, and the like. In a CHN, the nodes 405a-n have a hierarchical relationship (e.g., topology) that requires communications to flow through a formal chain. In a YN, the nodes 405a-n have a topology resembling an upside-down ‘Y’ (e.g., information flows upward and downward through the hierarchy). In a WN, data flows to and from a networked device (e.g., array 102). In a CIRN, the nodes 405a-n have a topology that restricts the flow of information to/from one node of the nodes to an adjacent node (e.g., a neighboring node). In embodiments, each node can have at most two adjacent nodes. In an ACN, the nodes 405a-n have a structure that allows communications to flow upward, downward, and laterally among each node. As illustrated, the network 118 can have an arrangement 400 consistent with an ACN. In embodiments, the network 118 can define one or more communication paths between the array 102 and hosts 1226a-n.

In embodiments, hosts 126a-n can connect to the network (e.g., SAN) 118 using Host Bus Adapters (HBAs) (e.g., respective HBAs 1-2) that are substantially similar to Network Interface Cards (NICs) in Ethernet networks. Each HBA (respective HBAs 1-2) includes ports P1-2 that are assigned unique World Wide Names (WWNs). The HBA ports P1-2 can connect to switch ports (e.g., ports P1-4 of switches 405a-n) via Fibre Channel links.

In embodiments, FC switches (e.g., switches 405a-n) can include multiple ports P1-8, each with its own WWN. The switches 405a-n can include switch host ports P1-4 connected to hosts. The switches 405a-n can also include switch storage ports P5-8 connected to one or more storage arrays (e.g., the storage array 102). Further, the switches 405a-n can be interconnected using Inter-Switch Links (ISLs) for redundancy and expanded connectivity.

In embodiments, a storage array 102 can include director boards 404/406 (e.g., substantially similar to director boards En:Bn of FIG. 3), each including a small input/output (IO) card (SLIC) 412a-b. Each SLIC can include multiple FC ports (e.g., ports P1-4) connected to corresponding switch storage ports P5-8 of respective switches 405a-n. Like other components (e.g., ports) of the network 118, the FC ports P1-4 on each SLIC 412a-b are assigned World Wide Names (WWNs). The SLICs 412a-b provide an interface between the storage array 102 and the external fabric corresponding to the network 118. Accordingly, the SLICs 412a-b allow the storage array 102 to connect to multiple FC switches (e.g., the FC switches 405a-n).

In embodiments, WWNs are unique identifiers in Fibre Channel networks, similar to IP addresses in Ethernet networks. Each networked device (e.g., HBA port, switch port, storage array port) is assigned a unique WWN. The WWNs can identify each networked device and port in the SAN 118. Additionally, the WWNs can be used to create logical zones that define which networked devices can communicate with each other. Specifically, zoning techniques use WWNs to create logical groups of networked devices that are allowed to communicate. Further, networked devices (e.g., the hosts 126a-n, FC switches 405a-n, and storage array 102) on the SAN 118 can implement multipathing techniques that use the WWNs to identify and manage multiple paths between the networked devices. Using WWNs, SAN administrators can precisely control and manage connectivity, security, and resource allocation in the Fibre Channel network, ensuring that only authorized networked devices can communicate and access specific resources.

In embodiments, the storage array 102 can include a controller 142 configured to enhance cache effectiveness during high input/output (IO) load periods. The controller leverages the Fabric Device Management Interface (FDMI) network infrastructure (e.g., SAN 118) to collect critical host information and track IO patterns across the storage fabric. The controller 142 can also implement machine learning capabilities to predict and prepare for IO bursts, while efficiently managing cache resources to optimize storage array performance. This optimization is particularly critical for modern software applications that rely heavily on host caching for improved performance.

The FDMI network 118 enables communication between hosts 126a-n and the storage array 102, allowing the controller 142 to identify and associate multiple Host Bus Adapters (HBAs) (e.g., HBAs 1-2) with their corresponding host systems 126a-n. This capability is essential because a single host may have multiple HBAs generating IO through different paths. Through FDMI, the controller 142 can aggregate and analyze IO patterns across all paths from the same host, providing a comprehensive view of application behavior.

Through the FDMI network 118, the controller 142 maintains awareness of the complete host connectivity topology, including all paths between hosts 126a-n and the storage array 102. This comprehensive view enables the controller 142 to aggregate IO statistics across all available paths, providing accurate workload analysis even in complex multi-path configurations. The controller 142 uses this information to track IO patterns and predict future high load periods that may require proactive cache resource management.

For instance, the controller 142 can use historical IO patterns to predict future high IO load periods. Specifically, the controller 142 can integrate Long Short-Term Memory (LSTM) networks and Bayesian Change Point Detection (BCP) to accurately forecast bursts and estimate their duration. Using LSTM, the controller 142 analyzes historical patterns to predict future values in the time series, while using BCP, the controller 142 identifies bursts by detecting sudden changes in mean and variance within the LSTM-generated forecasts. This dual-approach enables highly accurate prediction of both burst timing and duration.

To gather the necessary data for predictions, the controller 142 collects host information through the Fabric Device Management Interface (FDMI), including host names and virtual machine (VM) designations. This information, combined with IO statistics, allows the controller to track IO patterns on a per-application basis, even when multiple virtual machines are running on the same host. The controller 142 can distinguish between different applications and their specific IO patterns, enabling more accurate predictions and resource allocation. For example, the controller 142 can differentiate between an Oracle database performing regular dumps and a reporting application with different caching requirements.

The FDMI network's host identification capabilities are particularly valuable when tracking memory flush operations from database applications. When a database performs a memory dump, it generates a burst of write operations that may come through multiple HBAs. The FDMI network 118 allows the controller 142 to correlate these writes as coming from the same application, enabling proper prediction and preparation for these high-load events.

In backup scenarios, the FDMI network 118 helps the controller 142 identify backup servers and track their IO patterns separately from production hosts. This is crucial because backup operations generate distinct IO patterns, typically characterized by sustained read operations as data is transferred from the storage array to backup media. The controller uses FDMI information to predict these backup windows and prepare cache resources accordingly.

The controller leverages FDMI network data in conjunction with its machine learning capabilities to build comprehensive IO pattern profiles for each host and application. These profiles include information about which HBAs belong to which hosts, which VMs are running on each host, and the typical IO patterns associated with each workload. This detailed understanding enables the controller 142 to make informed decisions about cache resource allocation and optimization.

The FDMI network 118 infrastructure provides the foundation for the controller's ability to track and analyze IO patterns at multiple levels of granularity. By maintaining detailed host and path information through FDMI, the controller 142 can accurately predict and prepare for high IO load periods, ultimately optimizing cache utilization and storage array performance

When the controller 142 predicts an upcoming high IO load period, it assesses the current cache utilization. If cache utilization is high, the controller 142 initiates proactive measures to free cache resources before the predicted burst occurs. These measures are particularly important for handling memory flush operations, which create sudden loads of write commands, and other operations like backups that may cause floods of read miss commands. The controller's ability to prepare for these events helps prevent performance degradation during high-load periods.

For write operations, the controller 142 identifies write pending data in cache buffers. In embodiments, the controller 142 can delay writing data to disk for approximately 30 seconds to a minute, anticipating additional writes to the same cache slot to optimize write operations. This optimization is particularly important for flash storage, where writing larger chunks of data (e.g., 128K) is more efficient than multiple smaller writes (e.g., sixteen 8K writes). However, when preparing for a predicted IO burst, the controller 142 increases the write urgency for pending data to free up cache buffers preemptively. This approach ensures optimal use of flash storage while maintaining sufficient cache availability for incoming bursts.

For read operations, the controller 142 identifies cache buffers containing previously read data that has not yet been evicted from a Least Recently Used (LRU) queue (not shown). The controller 142 can evict this read data to make cache buffers available for the incoming IO burst. While this may temporarily reduce read hit probability, it ensures sufficient cache resources for handling the predicted high IO load. This trade-off is particularly relevant during backup operations, which generate significant read traffic as data is transferred from the storage array to backup media through processes like FTP transfers to backup servers.

In storage arrays with separate read and write caches, the controller 142 can dynamically reallocate cache resources by relocating read cache buffers to the write cache to increase its size. This flexibility allows the controller 142 to optimize cache resource allocation based on the predicted IO patterns and workload characteristics. The controller's ability to adjust cache allocation dynamically is especially valuable when dealing with mixed workloads that have varying read and write requirements.

The controller's burst prediction capabilities are particularly effective for recurring patterns, such as scheduled database dumps or backup operations. For example, if a database is configured to perform memory dumps every 5-10 minutes, or if backups are scheduled at specific times (e.g., 8:00 PM daily), the controller 142 can learn these patterns and prepare cache resources accordingly. This predictive capability is enhanced by the controller's ability to track multiple hosts through FDMI information, even when they use multiple Host Bus Adapters (HBAs). The controller 142 can associate multiple HBAs with a single host, providing comprehensive IO pattern analysis across all paths.

The controller 142 employs sophisticated burst detection mechanisms using Bayesian Change Point detection to identify both the onset and duration of IO bursts. The burst length is calculated by measuring the time differences between consecutive detected change points, allowing the controller 142 to anticipate not only when bursts will occur but also how long they are likely to last. This temporal awareness enables more efficient resource allocation and cache management strategies, particularly for applications with regular IO patterns like database operations.

In embodiments, the controller 142 can implement a nuances cache management strategy when dealing with different types of cached data. For write pending data that hasn't been written to disk, the controller 142 can ensure the data is written before freeing the cache buffers, as this data cannot be discarded. However, for read data awaiting potential re-reads, the controller can immediately evict the data to free cache resources when preparing for an anticipated IO burst. This distinction is crucial for maintaining data integrity while optimizing cache resource utilization, especially in environments with mixed workloads.

In cases where the storage array 102 uses a unified cache for both reads and writes, the controller 142 manages a single pool of cache buffers, making allocation decisions based on the predicted IO patterns and current cache contents. This includes balancing the need to maintain frequently accessed read data against the requirement to handle incoming write bursts efficiently. The controller's decision-making process considers factors such as the likelihood of data reuse and the urgency of freeing cache resources for anticipated bursts.

In embodiments, the controller 142 can implement a machine learning technique that continuously refines its predictions based on observed IO patterns. By maintaining historical data about IO behavior from specific hosts, VMs, and applications, the controller 142 can adapt its cache management strategies to evolving workload patterns over time. This adaptive capability ensures optimal cache utilization even as application workload patterns change, or new applications are introduced to the system. The controller's learning capabilities extend to understanding application-specific behaviors, such as distinguishing between synchronous operations that require immediate response and asynchronous operations that can be handled with lower priority.

The controller's management of cache resources considers various application requirements, such as banking operations that require synchronous writes for data integrity versus reporting applications that can tolerate asynchronous operations. Further, the controller 142 can optimize cache management based on observed patterns and application behaviors. This includes understanding that certain applications, like banking systems, may be configured to accept only limited data loss windows (e.g., real-time, 5 minutes, etc.) and adjusting cache management strategies accordingly

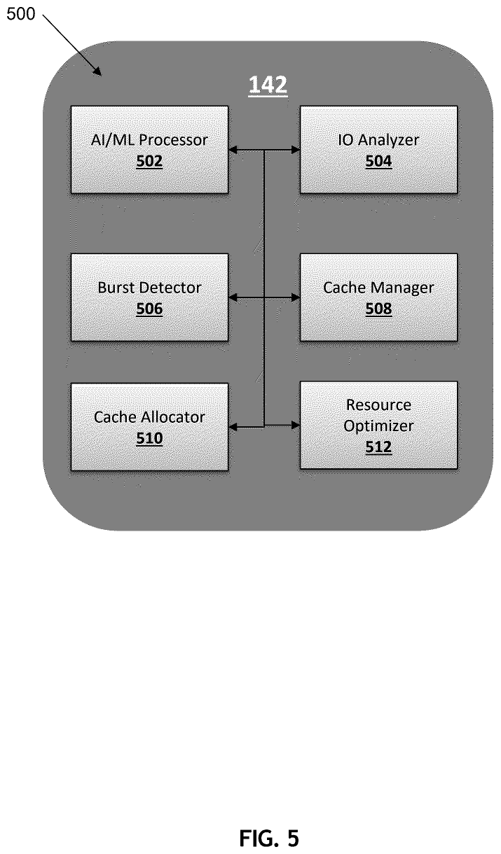

Regarding FIG. 5, a storage array (e.g., the storage array 102 of FIG. 1) can include a controller 142 with hardware, logic, and circuitry 500 that implement an intelligent cache management system that predicts and optimizes cache resources for high IO load periods in the storage array.

In embodiments, the controller 102 can include an AI/ML processor 502 that implements sophisticated machine learning capabilities to predict and analyze high IO load periods in a storage array system. The AI/ML processor 502 integrates Long Short-Term Memory (LSTM) networks with Bayesian Change Point Detection (BCP) to accurately forecast IO bursts and estimate their duration.

The AI/ML processor 502 processes historical IO patterns through its LSTM networks to predict future values in the time series. These LSTM networks are specifically designed to identify recurring patterns in IO operations, such as periodic memory flushes from database applications or scheduled backup operations.

Working in conjunction with the LSTM analysis, the AI/ML processor 502 employs Bayesian Change Point Detection to identify bursts by detecting sudden changes in mean and variance within the LSTM-generated forecasts. The burst length is determined by measuring the time difference between consecutive detected change points, allowing the AI/ML processor 502 to provide accurate predictions of both burst occurrence and duration.

The AI/ML processor 502 leverages host information gathered through the Fabric Device Management Interface (FDMI) to enhance its prediction accuracy. This includes collecting and analyzing host names, VM designations, and other relevant IO statistics that allow the AI/ML processor 502 to predict future IO pressure based on previous IO statistics.

A key capability of the AI/ML processor 502 is its ability to correlate IO activities across multiple host bus adapters (HBAs) that may belong to the same server or application. By utilizing FDMI information, the AI/ML processor 502 can determine when multiple HBAs are servicing the same application, allowing it to build a more comprehensive understanding of IO patterns.

In embodiments, the AI/ML processor 502 can identify cyclical IO patterns, such as those generated by database applications that perform regular memory dumps to permanent storage. These patterns might occur at fixed intervals, such as every five or ten minutes, or according to scheduled maintenance windows like nightly backups.

When the AI/ML processor 502 predicts an upcoming high IO load period, it triggers proactive cache resource management actions. These predictions enable the storage array to prepare for incoming IO bursts by freeing cache resources in advance, whether through evicting read data or expediting the writing of pending data to disk.

The AI/ML processor 502 maintains awareness of both read and write cache configurations, adapting its predictions and recommendations based on whether the storage array implements separate read and write caches or a combined cache architecture. This flexibility allows the AI/ML processor 502 to optimize cache resource management regardless of the underlying storage array implementation.

Through its integration of LSTM networks and Bayesian Change Point Detection, the AI/ML processor 502 provides two key advantages: it can predict burst occurrences before they happen, and it can accurately estimate burst duration. These capabilities enable the storage array to prepare cache resources proactively rather than reactively responding to high IO load conditions.

In embodiments, the controller 142 can include an IO analyzer 504 that collects and processes detailed IO statistics from hosts connected to the storage array to enable intelligent cache resource management. The IO analyzer 504 leverages the Fabric Device Management Interface (FDMI) to gather critical host identification information, including host names and virtual machine (VM) designations, which allows for precise tracking of IO patterns at both the physical and virtual machine levels.

A key capability of the IO analyzer 504 is its ability to correlate IO activities across multiple host bus adapters (HBAs) that may belong to the same server or application. By utilizing FDMI information, the IO analyzer 504 can determine when multiple HBAs are servicing the same application, enabling it to build a comprehensive understanding of IO patterns across the entire storage infrastructure.

The IO analyzer 504 processes IO statistics corresponding to each connected host, tracking patterns of both read and write operations. This includes analyzing memory flush operations, which create sudden loads of write commands, as well as read miss commands that may occur during operations such as backups or database table sorts.

For virtual environments, the IO analyzer 504 processes VM-ID information included with each IO operation, allowing it to distinguish between different virtual machines operating on the same physical host. This granular analysis enables the IO analyzer 504 to identify and track IO patterns specific to individual applications running within virtual machines.

The IO analyzer 504 works in conjunction with machine learning components to identify cyclical IO patterns, such as those generated by database applications that perform regular memory dumps to permanent storage. These patterns might occur at fixed intervals, such as every five or ten minutes, or according to scheduled maintenance windows like nightly backups.

The IO analyzer 504 processes IO statistics from hosts connected to the storage array, examining patterns in both read and write operations. When analyzing write operations, the IO analyzer 504 examines the timing and sequence of write acknowledgments to help distinguish between synchronous and asynchronous patterns. In synchronous operations, the IO analyzer 504 observes a sequential pattern where each write is followed by an acknowledgment before the next write occurs, indicating the application is waiting for confirmation before proceeding.

For asynchronous operations, the IO analyzer 504 detects burst patterns where multiple writes are sent without waiting for individual acknowledgments, characteristic of applications that continue processing while data is being written to storage. This pattern analysis is particularly relevant for database applications that perform periodic memory dumps, where the IO analyzer 504 can identify whether the application waits for write completion (synchronous) or continues processing during the dump (asynchronous).

The IO analyzer 504 examines write patterns in conjunction with application behavior, such as in database operations where synchronous writes typically occur in fixed intervals (e.g., every 5-10 minutes) with distinct pauses in processing, while asynchronous writes show more continuous, overlapping IO patterns.

Further, through its analysis of write timing and acknowledgment patterns, the IO analyzer 504 provides essential input for predicting and preparing for high IO load periods, enabling the storage array to optimize cache resource allocation based on the observed write patterns. This analysis helps inform cache management decisions while maintaining flexibility to adapt to different storage array implementations, whether using separate read and write caches or a combined cache architecture.

The IO analyzer 504 maintains awareness of both read and write cache configurations, adapting its analysis based on whether the storage array implements separate read and write caches or a combined cache architecture. This flexibility allows the IO analyzer 504 to provide relevant IO pattern information regardless of the underlying storage array implementation.

In embodiments, the IO analyzer 504 provides essential input for predicting and preparing for high IO load periods through its comprehensive analysis of host IO patterns. Its ability to correlate IO activities across multiple hosts and virtual machines, while considering both synchronous and asynchronous operations, enables the storage array to optimize cache resource allocation proactively rather than reactively responding to high IO load conditions.

The IO analyzer 504 continuously monitors and updates its analysis of IO patterns, ensuring that the storage array maintains current information about host IO behaviors and can adapt to changes in application workloads or scheduling patterns. This ongoing analysis enables dynamic optimization of cache resources based on actual usage patterns and anticipated IO demands.

In embodiments, the controller 142 can include a burst detector 506 that can identify and analyze IO burst patterns in storage array operations. Using Bayesian Change Point Detection (BCP), the Burst Detector 506 identifies bursts by detecting sudden changes in mean and variance within LSTM-generated forecasts. This detection mechanism allows the Burst Detector 506 to precisely determine both the onset and duration of IO bursts.

A key function of the Burst Detector 506 is measuring the time differences between consecutive detected change points to accurately determine burst length. This temporal analysis enables the storage array to understand not just when bursts occur, but also how long they are likely to persist.

The Burst Detector 506 processes different types of IO bursts, including memory flush operations that create sudden loads of write commands, as well as read miss commands that may occur during operations such as backups or database table sorts. For memory flush operations, the Burst Detector 506 analyzes patterns where applications write cached data to permanent storage in bursts, which may occur at regular intervals such as every 5-10 minutes.

When analyzing backup operations, the Burst Detector 506 identifies characteristic patterns of read miss commands, as these operations typically involve sequential reading of large amounts of data from storage for transfer to backup media. Similarly, for database table sorts, the Burst Detector 506 recognizes patterns of both read misses and subsequent writes that characterize these operations.

The Burst Detector 506 maintains awareness of both synchronous and asynchronous burst patterns. In synchronous operations, it detects bursts where applications pause processing until data transfer completes, while in asynchronous operations, it identifies patterns where applications continue processing during data transfer. This distinction helps inform cache resource management decisions.

Working with historical IO pattern data, the Burst Detector 506 helps identify cyclical burst behaviors, such as regular database memory dumps or scheduled backup operations. By detecting these patterns, the Burst Detector 506 enables the storage array to predict and prepare for future burst events.

The Burst Detector 506 provides essential input for cache resource management by identifying when high IO load periods are likely to occur and how long they may last. This information allows the storage array to proactively prepare cache resources, whether through evicting read data or expediting the writing of pending data to disk.

Through its integration with machine learning components, the Burst Detector 506 continuously refines its burst detection capabilities based on observed patterns and outcomes. This ongoing analysis enables dynamic optimization of cache resources based on actual usage patterns and anticipated IO demands In embodiments, the controller 142 can include a cache manager 508 that monitors and controls cache utilization in the storage array, maintaining detailed information about different types of cached data including write pending data and previously read data. The cache manager 508 tracks cache utilization across both write and read operations, adapting its management approach based on whether the storage array implements separate write and read caches or a combined cache architecture.

When informed of an upcoming high IO load period, the cache manager 508 evaluates current cache utilization to determine if cache resources need to be freed. For write cache buffers containing pending writes, the cache manager 508 can increase write urgency to ensure data is written to disk before the predicted high IO load period. This is particularly important as write pending data cannot be evicted until it has been successfully written to permanent storage.

The cache manager 508 handles memory flush operations where applications write cached data to permanent storage in bursts. During these operations, the cache manager 508 must process sudden loads of write commands while maintaining overall storage array performance. The cache manager 508 typically holds write data for brief periods, such as one to two seconds, hoping to accumulate multiple writes to the same location before writing to disk. This approach optimizes flash storage usage by reducing the number of individual write operations.

For read operations, the cache manager 508 maintains information about previously read data that may be awaiting reread operations. Unlike write pending data, this read data can be evicted from cache when necessary to free resources. The cache manager 508 makes strategic decisions about when to evict read data, balancing the potential impact on read hit probability against the need for available cache resources.

In storage arrays with separate write and read caches, the cache manager 508 can dynamically adjust cache resource allocation between read and write operations. This includes the ability to relocate read cache buffers to write cache buffers when additional write cache capacity is needed. The cache manager 508 coordinates these resource reallocations based on predicted IO patterns and current cache utilization.

In embodiments, the cache manager 508 works closely with other system components to optimize cache resource management during high IO load periods. When processing backup operations, for example, the cache manager 508 handles the flood of read miss commands as data is read from storage for transfer to backup media. Similarly, during database table sorts, the cache manager 508 must manage both read misses and subsequent writes effectively.

Through its comprehensive cache management capabilities, the cache manager 508 enables the storage array to prepare proactively for high IO load periods rather than reacting to them after they occur. This includes coordinating the eviction of read data and expediting the writing of pending data to ensure sufficient cache resources are available when needed

In embodiments, the controller 142 can include a cache allocator 510 that implements cache resource management decisions based on predictions of high IO load periods and current cache utilization states. When a high IO load period is predicted, the cache allocator 510 executes specific actions to free cache resources, coordinating with other system components to ensure optimal cache buffer availability.

For read cache buffers containing previously read data, the cache allocator 510 implements eviction procedures to make these buffers available for the incoming IO burst. Since read data can be evicted without first writing to disk, the cache allocator 510 prioritizes freeing read cache buffers when additional resources are needed. While this may temporarily reduce read hit probability, the cache allocator 510 makes this tradeoff to ensure sufficient cache resources are available for high-priority operations.

When dealing with write cache buffers containing pending writes, the cache allocator 510 coordinates with other components to increase write urgency and free these buffers before the predicted high IO load period. The cache allocator 510 may reduce the normal delay period for write operations, which typically allows for accumulation of multiple writes to the same location, to ensure write pending data is moved to permanent storage more quickly.

In storage arrays with separate read and write caches, the cache allocator 510 implements dynamic buffer reallocation between read and write caches. When additional write cache capacity is needed, the cache allocator 510 can relocate read cache buffers to serve as write cache buffers, effectively increasing the available write cache size. This flexibility allows the cache allocator 510 to adapt cache resources based on predicted IO patterns and current utilization levels.

The cache allocator 510 handles different types of IO bursts, including memory flush operations that create sudden loads of write commands and read miss commands that occur during operations such as backups or database table sorts.

During memory flush operations, the cache allocator 510 manages the allocation of cache buffers to handle the burst of write commands while maintaining overall storage array performance.

For backup operations, the cache allocator 510 manages cache buffer allocation to handle the flood of read miss commands as data is read from storage for transfer to backup media. Similarly, during database table sorts, the cache allocator 510 must efficiently allocate cache resources to handle both read misses and subsequent writes.

The cache allocator 510 works in conjunction with machine learning components to prepare cache resources proactively rather than reactively. When informed of an upcoming high IO load period, the cache allocator 510 begins implementing resource management decisions before the burst occurs, ensuring optimal cache buffer availability when needed.

Through its comprehensive cache allocation capabilities, the cache allocator 510 enables the storage array to maintain effective performance during high IO load periods by ensuring appropriate cache resources are available when needed. This includes managing the eviction of read data, expediting the writing of pending data, and coordinating buffer reallocation between read and write caches as required.

In embodiments, the controller 142 can include a resource optimizer 512 that manages cache resource allocation and optimization to maximize storage array performance during high IO load periods. When the storage array implements separate read and write caches, the resource optimizer 512 can dynamically determine when to relocate read cache buffers to write cache buffers to increase overall write cache capacity. This reallocation is particularly important when preparing for predicted high IO load periods that will require additional write cache resources.

The resource optimizer 512 prioritizes eviction decisions based on data type, distinguishing between read data that can be immediately evicted and write pending data that must first be written to disk. For write pending data, the resource optimizer 512 coordinates with other components to increase write urgency and ensure data is written to permanent storage before the predicted high IO load period. This approach optimizes flash storage usage by reducing the number of individual write operations while still ensuring sufficient cache resources are available when needed.

When processing memory flush operations, the resource optimizer 512 manages resource allocation to handle sudden loads of write commands while maintaining overall storage array performance. The resource optimizer 512 typically allows write data to accumulate briefly, aiming to combine multiple writes to the same location before initiating disk writes. However, when preparing for predicted high IO load periods, the resource optimizer 512 may adjust this strategy to ensure cache resources are freed more quickly.

For read operations, the resource optimizer 512 evaluates the impact of evicting previously read data against the need for available cache resources. While evicting read data may temporarily reduce read hit probability, the resource optimizer 512 makes this tradeoff when necessary to ensure sufficient cache resources are available for high-priority operations. This is particularly relevant during operations such as backups or database table sorts that generate significant read miss commands.

The resource optimizer 512 works in conjunction with machine learning components to implement proactive resource optimization rather than reactive responses. When informed of an upcoming high IO load period, the resource optimizer 512 begins implementing optimization decisions before the burst occurs, ensuring optimal cache resource availability. This includes coordinating the eviction of read data, expediting the writing of pending data, and managing buffer reallocation between read and write caches as required.

Through its comprehensive resource optimization capabilities, the resource optimizer 512 enables the storage array to maintain effective performance during high IO load periods by ensuring appropriate cache resources are available when needed. The resource optimizer 512 continuously adapts its optimization strategies based on predicted IO patterns and current cache utilization levels, balancing the needs of different types of IO operations while maintaining overall system performance.

The following text includes details of a method(s) or a flow diagram(s) per embodiments of this disclosure. For simplicity of explanation, each method is depicted and described as a set of alterable operations. Additionally, one or more operations can be performed in parallel, concurrently, or in a different sequence. Further, not all the illustrated operations are required to implement each method described by this disclosure.

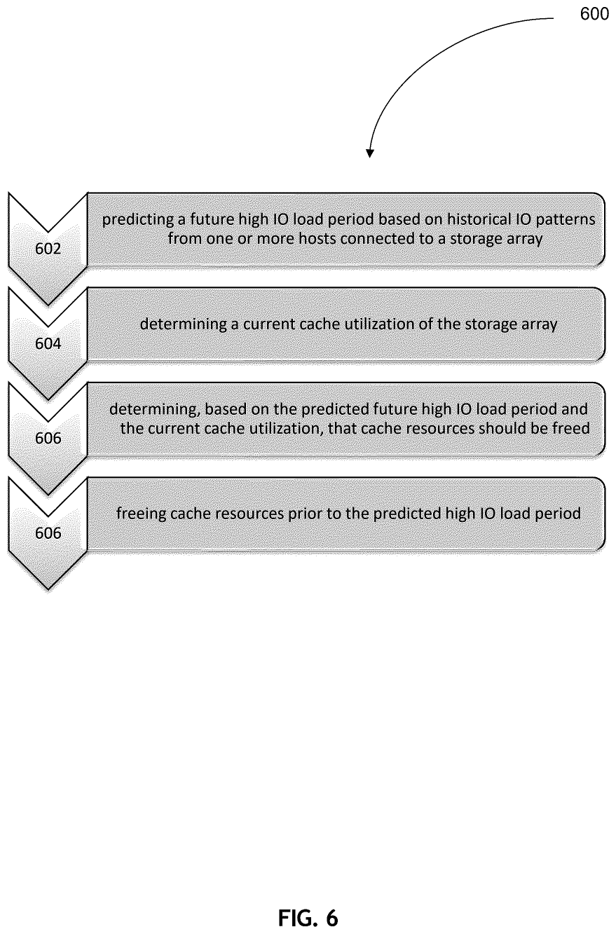

Regarding FIG. 6, a method 600 relates to managing cache resources in a storage array. In embodiments, the controller 142 of FIG. 1 can perform all or a subset of operations corresponding to the method 600.

For example, the method 600, at 602, can include predicting a future high input/output (IO) load period based on historical IO patterns from one or more hosts connected to a storage array. Additionally, at 604, the method 600 can include determining a current cache utilization of the storage array. Further, the method 600, at 606, can include determining, based on the predicted future high IO load period and the current cache utilization, that cache resources should be freed. At 608, the method 600 can also include freeing cache resources prior to the predicted high IO load period.

Further, each operation can include any combination of techniques implemented by the embodiments described herein. Additionally, one or more of the storage array's components 108 can implement one or more of the operations of each method described above.

Using the teachings disclosed herein, a skilled artisan can implement the above-described systems and methods in digital electronic circuitry, computer hardware, firmware, or software. The implementation can be a computer program product. Additionally, the implementation can include a machine-readable storage device for execution by or to control the operation of a data processing apparatus. The implementation can, for example, be a programmable processor, a computer, or multiple computers.

A computer program can be in any programming language, including compiled or interpreted languages. The computer program can have any deployed form, including a stand-alone program, subroutine, element, or other units suitable for a computing environment. One or more computers can execute a deployed computer program.

One or more programmable processors can perform the method steps by executing a computer program to perform the concepts described herein by operating on input data and generating output. An apparatus can also perform the steps of the method. The apparatus can be a special-purpose logic circuitry. For example, the circuitry is an FPGA (field-programmable gate array) or an ASIC (application-specific integrated circuit). Subroutines and software agents can refer to portions of the computer program, the processor, the special circuitry, software, or hardware that implements that functionality.

Processors suitable for executing a computer program include, by way of example, both general and special purpose microprocessors and any one or more processors of any digital computer. A processor can receive instructions and data from a read-only memory, a random-access memory, or both. Thus, for example, a computer's essential elements are a processor for executing instructions and one or more memory devices for storing instructions and data. Additionally, a computer can receive data from or transfer data to one or more mass storage device(s) for storing data (e.g., magnetic, magneto-optical disks, solid-state drives (SSDs, or optical disks).

Data transmission and instructions can also occur over a communications network. Information carriers that embody computer program instructions and data include all nonvolatile memory forms, including semiconductor memory devices. The information carriers can, for example, be EPROM, EEPROM, flash memory devices, magnetic disks, internal hard disks, removable disks, magneto-optical disks, CD-ROM, or DVD-ROM disks. In addition, the processor and the memory can be supplemented by or incorporated into special-purpose logic circuitry.

A computer with a display device enabling user interaction can implement the above-described techniques, such as a display, keyboard, mouse, or any other input/output peripheral. The display device can, for example, be a cathode ray tube (CRT) or a liquid crystal display (LCD) monitor. The user can provide input to the computer (e.g., interact with a user interface element). In addition, other kinds of devices can enable user interaction. Other devices can, for example, be feedback provided to the user in any form of sensory feedback (e.g., visual feedback, auditory feedback, or tactile feedback). For example, input from the user can be in any form, including acoustic, speech, or tactile input.

A distributed computing system with a back-end component can also implement the above-described techniques. The back-end component can, for example, be a data server, a middleware component, or an application server. Further, a distributing computing system with a front-end component can implement the above-described techniques. The front-end component can, for example, be a client computer with a graphical user interface, a web browser through which a user can interact with an example implementation or other graphical user interfaces for a transmitting device. Finally, the system's components can interconnect using any form or medium of digital data communication (e.g., a communication network). Examples of communication network(s) include a local area network (LAN), a wide area network (WAN), the Internet, a wired network(s), or a wireless network(s).

The system can include a client(s) and server(s). The client and server (e.g., a remote server) can interact through a communication network. For example, a client-and-server relationship can arise when computer programs run on the respective computers and have a client-server relationship. Further, the system can include a storage array(s) that delivers distributed storage services to the client(s) or server(s).

Packet-based network(s) can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network(s), 802.16 network(s), general packet radio service (GPRS) network, HiperLAN), or other packet-based networks. Circuit-based network(s) can include, for example, a public switched telephone network (PSTN), a private branch exchange (PBX), a wireless network, or other circuit-based networks. Finally, wireless network(s) can include RAN, Bluetooth, code-division multiple access (CDMA) networks, time division multiple access (TDMA) networks, and global systems for mobile communications (GSM) networks.

The transmitting device can include, for example, a computer, a computer with a browser device, a telephone, an IP phone, a mobile device (e.g., cellular phone, personal digital assistant (PDA) device, laptop computer, electronic mail device), or other communication devices. The browser device includes, for example, a computer (e.g., desktop computer, laptop computer) with a World Wide Web browser (e.g., Microsoft® Internet Explorer® and Mozilla®). The mobile computing device includes, for example, a Blackberry®.

Comprise, include, or plural forms of each are open-ended, include the listed parts, and contain additional unlisted elements. Unless explicitly disclaimed, the term ‘or’ is open-ended and includes one or more of the listed parts, items, elements, and combinations thereof.

1. A method comprising:
predicting a future high input/output (IO) load period based on historical IO patterns from one or more hosts connected to a storage array;
determining a current cache utilization of the storage array;
determining, based on the predicted future high IO load period and the current cache utilization, that cache resources should be freed;
identifying write pending data in cache buffers;
increasing a write urgency for the write pending data to free up cache buffers before the predicted high IO load period; and
freeing cache resources prior to the predicted high IO load period.

2. The method of claim 1, further comprising:
analyzing the historical IO patterns using Long Short-Term Memory (LSTM) networks to predict future IO loads in a time series; and
using Bayesian Change Point Detection to identify bursts by detecting sudden changes in mean and variance within LSTM-generated forecasts.

3. The method of claim 1, further comprising:
collecting host name information from Fabric Device Management Interface (FDMI);
collecting virtual machine (VM) designations; and
analyzing IO statistics corresponding to each of the one or more hosts.

4. (canceled)

5. The method of claim 1, further comprising:
identifying read cache buffers containing previously read data; and
evicting the previously read data from the read cache buffers to make the read cache buffers available for the predicted high IO load period.

6. The method of claim 1, further comprising:
relocating read cache buffers to write cache buffers to increase write cache capacity when the storage array has separate read and write caches.

7. The method of claim 1, further comprising:
evicting read data from cache buffers to free cache resources.

8. The method of claim 1, further comprising:
using Long Short-Term Memory (LSTM) neural networks to analyze historical IO patterns and predict future IO load values.

9. The method of claim 1, further comprising:
using Bayesian Change Point detection to identify IO burst onset and determine IO burst duration.

10. The method of claim 1, further comprising:
determining burst length by measuring time differences between consecutive detected change points in the Bayesian Change Point Detection.

11. An apparatus with a memory and processor, the apparatus configured to:
predict a future high input/output (IO) load period based on historical IO patterns from one or more hosts connected to a storage array;
determine a current cache utilization of the storage array;
determine, based on the predicted future high IO load period and the current cache utilization, that cache resources should be freed;
identify write pending data in cache buffers;
increase a write urgency for the write pending data to free up cache buffers before the predicted high IO load period; and
free cache resources prior to the predicted high IO load period.

12. The apparatus of claim 11, further configured to:
analyze the historical IO patterns using Long Short-Term Memory (LSTM) networks to predict future IO loads in a time series; and
use Bayesian Change Point Detection to identify bursts by detecting sudden changes in mean and variance within LSTM-generated forecasts.

13. The apparatus of claim 11, further configured to:
collect host name information from Fabric Device Management Interface (FDMI);
collect virtual machine (VM) designations; and
analyze IO statistics corresponding to each of the one or more hosts.

14. (canceled)

15. The apparatus of claim 11, further configured to:
identify read cache buffers containing previously read data; and
evict the previously read data from the read cache buffers to make the read cache buffers available for the predicted high IO load period.

16. The apparatus of claim 11, further configured to:
relocate read cache buffers to write cache buffers to increase write cache capacity when the storage array has separate read and write caches.

17. The apparatus of claim 11, further configured to:
evict read data from cache buffers to free cache resources.

18. The apparatus of claim 11, further configured to:
use Long Short-Term Memory (LSTM) neural networks to analyze historical IO patterns and predict future IO load values.

19. The apparatus of claim 11, further configured to:
use Bayesian Change Point detection to identify IO burst onset and determine IO burst duration.

20. The apparatus of claim 11, further configured to:
determine burst length by measuring time differences between consecutive detected change points in the Bayesian Change Point Detection.
